(19) United States
(12) Patent Application Publication
(10) Pub. No.: US 2024/0057598 A1
(43) Pub. Date: Feb. 22, 2024

(54) USE OF 2-AMINO-3-METHYLHEXANOIC ACID AS PLANT IMMUNITY INDUCER

(71) Applicants: NANJING AGRICULTURAL UNIVERSITY, Nanjing, Jiangsu (CN); NANJING TIANNONG BIOTECHNOLOGY CO., LTD., Nanjing, Jiangsu (CN)

(72) Inventors: Shiguo CHEN, Nanjing (CN); Qian YANG, Nanjing (CN); Liru MI, Nanjing (CN); He WANG, Nanjing (CN); Jingjing LI, Nanjing (CN); Wanping FANG, Nanjing (CN); Aiping GUO, Nanjing (CN)

(73) Assignees: NANJING AGRICULTURAL UNIVERSITY, Nanjing, Jiangsu (CN); NANJING TIANNONG BIOTECHNOLOGY CO., LTD., Nanjing, Jiangsu (CN)

(21) Appl. No.: 18/269,680

(22) PCT Filed: Dec. 20, 2021
(86) PCT No.: PCT/CN2021/139598

§ 371 Date: Jun. 26, 2023

(30) Foreign Application Priority Data
Dec. 24, 2020 (CN) 202011549486.6

(51) Int. Cl. A01N 37/44; A01P 21/00

(52) U.S. Cl. CPC A01N 37/44; A01P 21/00

(57) ABSTRACT

Disclosed is use of 2-amino-3-methylhexanoic acid as a plant immunity inducer and in the preparation of a plant immunity inducer. The development of 2-amino-3-methylhexanoic acid as an active substance into a plant immunity inducer can be used for improving the resistance of plants to biotic and abiotic stresses, effectively stop the infection and reduce the pathogenic levels of fungi, viruses and bacteria on plants, and at the same time, significantly improve the tolerance of plants to high temperature, low temperature, drought and salt stress. 2-amino-3-methylhexanoic acid has the features of being safe, environmentally friendly, and highly efficient.

### TECHNICAL FIELD

The present disclosure belongs to the field of agricultural biological pesticides, and relates to use of 2-amino-3-methylhexanoic acid as a plant immunity inducer.

### BACKGROUND

Plants are constantly infected by various pathogenic microorganisms during their growth and development. Once numerous diseases occur in agricultural production, they cannot be controlled by existing agricultural technologies. Therefore, disease prevention is particularly important. At present, the control of plant diseases mainly adopts the strategy of directly killing pathogens using pesticides. However, long-term and extensive use of fungicides, coupled with unscientific use methods, not only brings about a series of problems such as excessive residues in agricultural products, crop phytotoxicity, pathogen resistance, environmental pollution, and reduction of biological diversity, but also makes the traditional “killing” strategy of plant protection face the risk of failure, seriously threatening sustainable development of agriculture and the security of food production. Therefore, it is of great significance to develop environment-friendly, efficient and economical plant immunizing agents to reduce or inhibit the incidence of crop diseases by enhancing the plant's own resistance before or at the early stage of crop diseases, so as to achieve the goal of using less or no chemical fungicides, and to achieve green agricultural production.

In recent years, global temperature has fluctuated increasingly, more and more extreme weather has occurred, and abiotic stresses faced by plants become more and more serious. In agricultural production, the losses caused by high temperature, low temperature, drought and salt stress are incalculable. High temperature and low temperature seriously affect the growth and development of plants, and then affect the yield and quality of plants. Drought is one of the most important stress factors that affect the survival, growth and distribution of plants. At present, the area of arid and semi-arid regions in the world accounts for 40% or more of the total cultivated land area. In recent years, due to global climate deterioration, the occurrence cycle of drought has become shorter and shorter, the degree of drought has become more and more serious, and the threat to food production is also growing. In addition, soil salinization is a major abiotic limiting factor hindering global crop growth and productivity, which has a great harmful impact on the biosphere and ecological structure. China's saline-alkali land area ranks third in the world, accounting for about 10% of the world's saline-alkali land area. Therefore, in view of the main abiotic stresses faced by different crops in the current actual production, it is particularly urgent to develop products and technologies aimed at reducing the level of plant damage to ensure safe agricultural production.

Plant immunity inducers are a new class of biological pesticides, which can enhance the disease resistance and stress resistance of plants by activating the plant immune system and regulating plant metabolism. Plant immunity inducers do not have direct fungicidal activity, and are not likely to induce resistance of pathogenic bacteria. Rather than relying on foreign pesticides to directly kill pathogens, plant immunity inducers promote plants to use their own natural immune system to control diseases, which conforms to the idea of green control under the conditions of effective protection of agricultural biological diversity. In addition, in nature, plant growth is usually subject to not only a single stress, but also coexistence of multiple stresses, for example, drought and high temperature stresses often occur at the same time, causing more serious harm to plants. Although plants have their own immune system, their ability to resist stress is limited. The use of plant immunity inducers can increase the level of resistance of plants. In a word, plant immunity inducers, as a new class of pesticides, provide new development ideas for sustainable development of agriculture and effective disease control, and are the main direction of the future development of green plant protection.

2-amino-3-methylhexanoic acid (MIA), with experimental formula of C₇H₁₅NO₂ and molecular weight of 145 g/mol, belongs to a new type of amino acid compound and is colorless transparent crystal. There are 5 papers about the biological origin and activity of this compound. In 1981, Sugiura et al. isolated 2-amino-3-methylhexanoic acid from the α-aminobutyrate resistant mutant of Serratia marcescens, a bacterial mutant, and found that it was synthesized by α-ketovaleric acid from the enzyme of an isoleucine-valine biosynthesis pathway. In 1985, the team speculated that 2-amino-3-methylhexanoic acid might inhibit biosynthesis of isoleucine. The biological activity study shows that 2-amino-3-methylhexanoic acid has an obvious inhibitory effect on Bacillus subtilis and Escherichia coli K-12, a slight inhibitory effect on Achromobacter butyri, A. ureafaciens, E. coli B and Pseudomonas aeruginosa, and no inhibitory effect on Aerobacter aerogenes, Brevibacterium helvolum, P. fluorescens and S. marcescens. In addition, in 2002, Muramatsu et al. found that the engineered E. coli producing hirudin analogues could synthesize 2-amino-3-methylhexanoic acid, but did not study its activity. Up to now, there are few studies on 2-amino-3-methylhexanoic acid, studies focus on the biosynthetic pathway for synthesizing 2-amino-3-methylhexanoic acid using bacterial mutants or recombinant engineered bacteria (non-natural microorganisms) and direct inhibition of bacterial activity. There are no reports on natural microorganisms producing 2-amino-3-methylhexanoic acid, and there are no relevant studies, reports or patents related to plant immunity induction.

### SUMMARY

The objective of the present disclosure is to provide use of 2-amino-3-methylhexanoic acid as a plant immunity inducer in view of the above shortcomings in the prior art.

The objective of the present disclosure may be achieved by using the following technical solutions.

Use of 2-amino-3-methylhexanoic acid in preparation of a plant immunity inducer.

Use of 2-amino-3-methylhexanoic acid in improving resistance of plants to abiotic stress and/or biotic stress.

Use of 2-amino-3-methylhexanoic acid in improving resistance of plants to high temperature, low temperature, drought and/or salt stresses.

Use of 2-amino-3-methylhexanoic acid in improving resistance of plants to stresses of fungi, bacteria and viruses.

Use of 2-amino-3-methylhexanoic acid in control of fungal disease, bacterial disease and/or viral disease in plants.

The fungal disease is preferably wheat powdery mildew; the bacterial disease is preferably Pseudomonas syringae infection; and the viral disease is preferably tomato spotted wilt.

The plants are selected from food crops, cash crops and vegetables. The food crops are preferably wheat, the cash crops are preferably tea, cotton and ryegrass, and the vegetables are preferably tomato.

A plant immunity inducer includes 2-amino-3-methylhexanoic acid.

As a preferred embodiment of the present disclosure, the plant immunity inducer includes 2-amino-3-methylhexanoic acid and a surfactant.

As a further preferred embodiment of the present disclosure, the surfactant is Tween 20, and the concentration of Tween 20 in the plant immunity inducer is preferably 0.02% (v/v).

As a further preferred embodiment of the present disclosure, the concentration of 2-amino-3-methylhexanoic acid in the plant immunity inducer is 0.5-10,000 nM; and further preferably, the concentration of 2-amino-3-methylhexanoic acid is 0.5-10 nM, 10-10,000 nM, 10-100 nM, 1-1,000 nM, 100-10,000 nM, 100-1,000 nM or 1-100 nM.

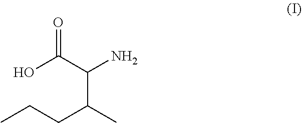

The existing research on 2-amino-3-methylhexanoic acid has not involved the reports on natural microbial metabolites and biological pesticides. As a new type of pesticide, plant immunity inducers are the main development direction of green control in the field of plant protection in the future. The development of immunity inducers in China is in its infancy, and there are very few products officially registered. Therefore, it is of great significance to develop natural plant immunity inducers and promote their industrialization for ensuring the safety of agricultural production and improving the competitiveness of agricultural products. 2-amino-3-methylhexanoic acid performs well in the relevant immune stress resistance induction experiments, and can improve the resistance of plants to biotic and abiotic stresses.

A method for controlling diseases using a natural metabolite 2-amino-3-methylhexanoic acid isolated from pathogenic Alternaria alternata of an exotic invasive plant Eupatorium adenophorum includes the details and embodiments as follows: in a concentration range of 0.5-10,000 nM (a 0.02% surfactant Tween 20 by volume is added), 2-amino-3-methylhexanoic acid can effectively inhibit the infection and spread of viruses, fungi and bacteria on plants, inhibit the occurrence and spread of diseases, and improve the resistance of plants to high temperature, low temperature, drought and salt stresses.

A method for improving the resistance of plants to biotic stress, includes: applying the plant immunity inducer of the present disclosure to plants in advance, the biotic stress being selected from any one or more of fungi, bacteria and viruses.

A method for controlling tomato spotted wilt using 2-amino-3-methylhexanoic acid is as follows: at a concentration of 0.5-10 nM (a 0.02% surfactant Tween 20 by volume is added), 2-amino-3-methylhexanoic acid can significantly inhibit the spread of tomato spotted wilt virus (TSWV) 3 days after inoculation in tobacco. After 15 days, investigation of the disease condition of the tobacco finds that the disease index of tobacco plants treated with the 2-amino-3-methylhexanoic acid significantly decreases. At a low concentration of 0.5 nM, 2-amino-3-methylhexanoic acid can effectively inhibit the expression of TSWV on tobacco leaves, and the disease index, relative immune effect and virus content are 38.52, 59.06% and 0.18 respectively.

A method for controlling wheat powdery mildew using 2-amino-3-methylhexanoic acid is as follows: 10 days after wheat is inoculated with powdery mildew fungus, investigation finds that with the increase of treatment concentration in a range of 1-10,000 nM (a 0.02% surfactant Tween 20 by volume is added), the disease index of wheat infected with powdery mildew decreases, and the relative immune effect increases; and at a high concentration of 10,000 nM, the disease index is 32.96, and the relative immune effect is 65.37%. By observing the distribution of mycelia on wheat leaves, it is found that the number of mycelia and conidia decreases significantly with the increase of concentration. Therefore, 2-amino-3-methylhexanoic acid has a significant inhibitory effect on the occurrence and spread of wheat powdery mildew.

A method for controlling bacterial diseases using 2-amino-3-methylhexanoic acid is as follows: in a concentration range of 10-100 nM (a 0.02% surfactant Tween 20 by volume is added), with the increase of the treatment concentration, the accumulation of bacterial PstDC3000 in Arabidopsis leaves gradually decreases. When the treatment concentration is 100 nM, the number of bacteria in each milligram of leaf is 2.49×10⁵, the number of bacteria decreases by 92.31% compared with the blank control, and the disease index is 41.48. The result shows that 2-amino-3-methylhexanoic acid can stimulate the autoimmunity of Arabidopsis, inhibit the propagation of bacteria in plants, reduce the accumulation of bacteria, and delay and inhibit the development of diseases.

A method for improving the resistance of plants to high temperature using 2-amino-3-methylhexanoic acid is as follows: when ryegrass, wheat and tomato are treated and induced with a 2-amino-3-methylhexanoic acid solution at a concentration of 1-10,000 nM (a 0.02% surfactant Tween 20 by volume is added) at a seedling stage, it is found that after treatment at 45° C. for 12 h or 9 h and recovery at room temperature for 7 days, the heat injury index of plants in the treatment group is lower than that of the control group, and the biomass of the overground part is higher than that of the control group. The result shows that exogenous spraying of the 2-amino-3-methylhexanoic acid solution effectively alleviates the injury level of seedlings caused by high temperature.

A method for improving resistance of plants to abiotic stress, includes: applying the plant immunity inducer of the present disclosure to plants, the abiotic stress being selected from any one or more of high temperature, low temperature, drought and/or salt stresses.

Use of 2-amino-3-methylhexanoic acid in improving tea quality.

In August 2020, spray treatment was conducted on stems and leaves in the field of Sun Yat-sen Mausoleum Tea Garden in Nanjing using 2-amino-3-methylhexanoic acid solutions with four concentrations of 10, 100, 1,000 and 10,000 nM (a 0.02% surfactant Tween 20 by volume was added). It was found that treatment with the 2-amino-3-methylhexanoic acid solutions could effectively alleviate the injury caused by high temperature to tea leaves, wherein treatment at a concentration of 100 nM had the optimal effect, and the heat injury rate of tea leaves treated at this concentration was significantly lower than that of the control group. Moreover, the photosynthetic performance index PI_{ABS} of tea leaves was significantly higher than that of the control group, indicating that spraying 2-amino-3-methylhexanoic acid could effectively alleviate severe inhibitory effects of high temperature on photosynthesis of tea leaves. At the same time, the total amino acid content of tea leaves treated with the 2-amino-3-methylhexanoic acid solutions of different concentrations was significantly higher than that of the control group. Under normal temperature, treatment with 2-amino-3-methylhexanoic acid could also significantly increase the amino acid content in tea leaves, which indicates that the 2-amino-3-methylhexanoic acid has the effect of improving the quality of tea.

A method for improving the resistance of plants to drought stress using 2-amino-3-methylhexanoic acid is as follows: the leaves of water cultured wheat with two leaves and one bud are sprayed with 100 and 1,000 nM 2-amino-3-methylhexanoic acid solutions (a 0.02% surfactant Tween 20 by volume is added). It is found that under the stress of 25% polyethylene glycol 6000 (PEG-6000), the root length of the wheat treated at 100 nM is significantly greater than that of the control group, which indicates that the 2-amino-3-methylhexanoic acid improves the resistance of wheat to drought stress.

A method for improving the resistance of plants to salt stress using the 2-amino-3-methylhexanoic acid is as follows: water cultured cotton at the true leaf stage with two leaves was sprayed with 2-amino-3-methylhexanoic acid solutions at concentrations of 1-1,000 nM (a 0.02% surfactant Tween 20 by volume is added). It is found that under the stress of 100 nM NaCl, the mortality and salt injury index of cotton treated at 10 nM are lower than those of the control group, which indicates that the 2-amino-3-methylhexanoic acid improves the salt tolerance of cotton.

A method for improving the resistance of plants to low temperature using 2-amino-3-methylhexanoic acid is as follows: the leaves of tea seedlings are sprayed with 2-amino-3-methylhexanoic acid solutions at concentrations of 1-1,000 nM (a 0.02% surfactant Tween 20 by volume is added). It is found that after 24 h of low temperature stress at −4° C., the photosynthetic performance index PI_{ABS} of the tea seedlings treated at 100 nM and 1,000 nM is significantly higher than that of the control group, and the cold injury index is significantly lower than that of the control group, indicating that the 2-amino-3-methylhexanoic acid effectively alleviates the injury caused by low temperature to tea seedlings and improves the resistance of tea leaves to low temperature stress.

Technological Sophistication and Beneficial Effects

Main advantages and positive effects of the present disclosure are as follows:

2-amino-3-methylhexanoic acid is a natural product with simple structure and is easy to be artificially synthesized. Since the present disclosure confirms that 2-amino-3-methylhexanoic acid can induce plants to produce immune activity against some serious diseases existing in agricultural production, and can induce plants to produce resistance to the more prominent abiotic stresses faced in agricultural production, 2-amino-3-methylhexanoic acid has the potential to be developed as a natural plant immunity inducer.

The present disclosure finds that 2-amino-3-methylhexanoic acid has high broad-spectrum immunity induction activity, and can induce tobacco to produce immune response to prevent the occurrence and spread of tomato spotted wilt at a low concentration of 0.5 nM, induce wheat to produce a 55.06% relative immune effect against powdery mildew at a concentration of 1,000 nM, and inhibit the accumulation of Pseudomonas syringae PstDC3000 in Arabidopsis leaves and reduce the disease index of Arabidopsis at a concentration of 100 nM. In response to abiotic stress, 2-amino-3-methylhexanoic acid can induce ryegrass, tomato, wheat and tea to improve their resistance to high temperature, and improve the resistance of wheat to drought and tea to low temperature at a concentration of 100-10,000 nM, and significantly improve the salt resistance of cotton at a concentration of 100 nM. In addition, at room temperature, at a treatment concentration of 10 nM, 2-amino-3-methylhexanoic acid can improve the nutritional quality of tea. 2-amino-3-methylhexanoic acid is a highly effective biological pesticide due to low consumption and less environmental pollution, indicating the utilization value and use prospect thereof in agricultural production.

The present disclosure may be used for controlling major fungal diseases occurring in farmland, such as wheat powdery mildew; viral diseases, such as tomato spotted wilt; and bacterial diseases, such as those caused by Pseudomonas syringae, indicating that the compound can induce plants to produce immune response to various types of diseases. At the same time, 2-amino-3-methylhexanoic acid can induce plants to resist a variety of abiotic stresses in nature, such as high temperature, low temperature, drought and salt stresses, providing a technical reference for alleviating the injury to plants caused by various stresses.

The present disclosure finds that 2-amino-3-methylhexanoic acid may prevent the occurrence and spread of a variety of major diseases in agricultural production by treatment of stems and leaves, and can reduce the inhibition of crops caused by various abiotic stresses during growth and development. 2-amino-3-methylhexanoic acid is easy to use, and can play a role in early prevention, reduce the injury level of plants caused by a variety of biotic and abiotic stresses, reduce the consumption of pesticides, and save production costs. In addition, 2-amino-3-methylhexanoic acid is a naturally occurring metabolite with simple structure, belongs to α-amino acids, has high environmental and biological safety, and belongs to the category of green and efficient biochemical pesticides.

### BRIEF DESCRIPTION OF THE DRAWINGS

FIG. 1 shows the effect of 2-amino-3-methylhexanoic acid on tobacco leaves infected by tomato spotted wilt viruses (TSWV).

FIG. 2 shows the effect of 2-amino-3-methylhexanoic acid on the distribution of powdery mildew fungus on wheat leaves.

### DETAILED DESCRIPTION

The inventors have studied the biological activity, scope of use and crop safety of 2-amino-3-methylhexanoic acid, and found that the substance is a natural plant immunity inducer and has the potential to be developed as a biological pesticide. At the same time, the research ideas provide a new direction for the development of biological pesticides, disease control and alleviation of abiotic stress. The substantive features of the present disclosure may be embodied from the following embodiments and examples, but these should not be construed as any limitation to the present disclosure.

### EXAMPLE 1

### 2-amino-3-methylhexanoic Acid Induced Resistance of Tobacco to Tomato Spotted Wilt Virus Infection

Tomato spotted wilt virus was obtained from Yunnan Province, China. The initial virus source was stored in a refrigerator at −80° C. Nicotiana benthamiana leaves were inoculated with the virus by mechanical inoculation to activate the virus. Viral plasmids were extracted and transformed by competent cells of Escherichia coli. The competent cells were spread on a resistant plate and cultured. Single colonies were selected for PCR screening. Positive colonies were selected for sequencing and subsequent plasmid extraction. Plasmids with normal sequencing were added to competent cells of Agrobacterium, and the Agrobacterium was transformed by electroporation. A solution of the transformed Agrobacterium was spread on the correspondingly resistant screening plate, and cultured at 28° C. (±1) for 48 h. Single colonies of the Agrobacterium on the transformation plate were selected, placed in 5 mL of correspondingly resistant LB medium, and cultured overnight at 28° C. and 180 rpm. Bacterial cells were collected by 2 min of centrifugation at 6,000 rpm, and suspended with an Agrobacterium treatment buffer solution (10 mM MgCl₂, 10 mM MES, 10 μM Acetosyringone) until the OD₆₀₀ value of the suspension was 0.5, and the suspension was treated at 28° C. for 3 h in dark for use.

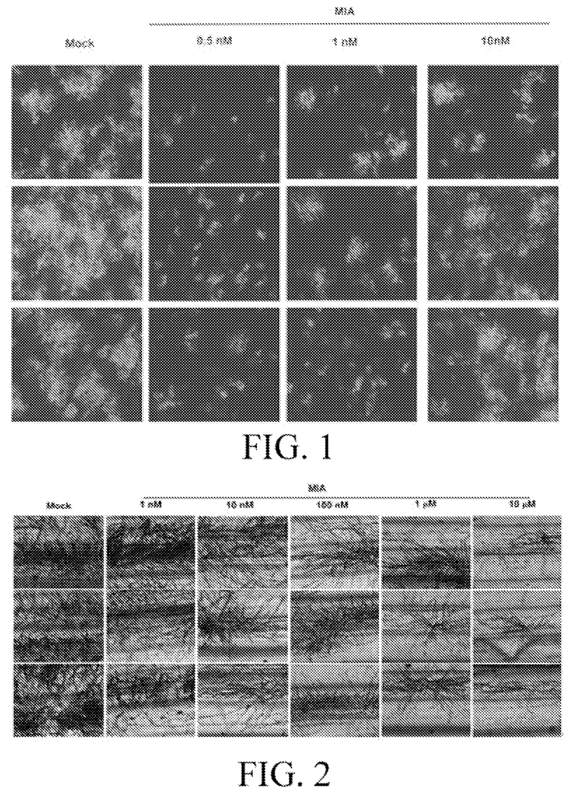

2-amino-3-methylhexanoic acid was dissolved in distilled water and then diluted with distilled water by gradient into solutions of 0 nM, 0.5 nM, 1 nM and 10 nM. Nicotiana benthamiana seeds were sowed in a small pot, and cultured at 22 (±1)° C., 16 h/8 h light for 5 weeks. Healthy tobacco plants (preferably with 8-10 leaves) were selected and treated with the 2-amino-3-methylhexanoic acid solutions of the above concentrations to conduct spray treatment on the stems and leaves. The treatment was repeated once after 24 h and conducted twice in total. After 24 h, the Agrobacterium solution with a uniform concentration was extracted using a 1 mL syringe, the injection port of the syringe was pressed directly on a small hole on the back of a tobacco leaf, and the bacterial solution was slowly pushed to soak the whole leaf. The soaked tobacco was moved to an environment of 22 (±1)° C. and cultured under 16 h/8 h light. 3 days later, microscopic observation was conducted. The results are shown in FIG. 1. At the same time, samples were taken. The gray scale of protein bands was analyzed by Western blot combined with ImageJ software, and the relative protein content of the virus in the leaves was determined. The incidence of tobacco leaves was observed 15 days later, and the disease indexes were recorded according to the Grade and Investigation Method of Tobacco Diseases and Insect Pests (GB/T23222-2008) using a formula as follows:

$$Disease index = \frac{\sum [ ( \begin{matrix}Number of diseased \\ leaves at all grades\end{matrix} \times \begin{matrix}Relative \\ grade value\end{matrix} ) ] \times 100}{Total number of leaves investigated \times 9}$$

$$\begin{matrix}Relative \\ immune effect\end{matrix} = \frac{\begin{matrix}Disease index of \\ blank control\end{matrix} - \begin{matrix}Disease index of \\ treatment group\end{matrix}}{Disease index of blank control} \times 100 \%$$

Grading standard of tomato spotted wilt virus infection (grading and investigation were conducted per plant):
Grade 0: The whole plant is disease free.
Grade 1: Heart leaves have clear veins or are slightly mottled, and the diseased plant is not obviously dwarfed.
Grade 3: One-third of leaves are mottled without deformation, or the diseased plant is dwarfed to three quarters or more of a normal plant in height.
Grade 5: One-third to one-half of leaves are mottled, or a few leaves are deformed, or the main veins become black, or the plant is dwarfed to two-thirds to three-quarters of a normal plant in height.
Grade 7: One-half to two-thirds of leaves are mottled or deformed, or a few main and lateral veins become necrotic, or the plant is dwarfed to one-half to two-thirds of a normal plant in height.
Grade 9: The leaves of the whole plant are mottled, seriously deformed or necrotic, or the diseased plant is dwarfed to one-half or more of a normal plant in height.

TABLE 1
Effect of 2-amino-3-methylhexanoic acid of different concentrations
on tobacco infected with tomato spotted wilt virus

| Treatment | | | Relative immune | Content of |
|---|---|---|---|---|
| concentration | | Disease index | effect | virus protein |
| 0 | | 94.07 ± 1.28a | — | 0.65 ± 0.010a |
| 0.5 | nM | 38.52 ± 3.39d | 59.06 | 0.18 ± 0.001d |
| 1 | nM | 44.81 ± 3.90c | 52.36 | 0.33 ± 0.001c |
| 10 | nM | 73.33 ± 2.22b | 22.05 | 0.44 ± 0.007b |

The results in Table 1 and FIG. 1 show that when the 2-amino-3-methylhexanoic acid was in a concentration range of 0.5-10 nM, the treatment at each concentration could significantly reduce the infection of tobacco with tomato spotted wilt virus. The disease index of tobacco infected with tomato spotted wilt virus was lower than 75, and the relative immune effect was 20% or more. In the concentration range, with the increase of concentration, the disease index of tobacco infected with tomato spotted wilt virus significantly decreased, the relative immune effect increased, and the content of virus protein in tobacco leaves decreased. When the treatment concentration was 0.5 nM, the immune effect of tobacco against tomato spotted wilt virus was the best, and the disease index, relative immune effect and virus content were 38.52, 59.06% and 0.18 respectively. The above results indicate that 2-amino-3-methylhexanoic acid can improve the immunity of tobacco against tomato spotted wilt virus, and effectively inhibit the spread of tomato spotted wilt virus in tobacco.

### EXAMPLE 2

### 2-amino-3-methylhexanoic Acid Induced Resistance of Wheat to Powdery Mildew Fungus Infection

2-amino-3-methylhexanoic acid was dissolved in distilled water and diluted with distilled water into solutions of 1 nM, 10 nM, 100 nM, 1,000 nM and 10,000 nM by gradient, and blank control was additionally set. Wheat seeds were germinated, planted in a sterilized soil culture pot and cultured in a greenhouse at 23(±1)° C. with light for 12 h. When the seedlings grew to the stage of one leaf and one bud, the stems and leaves of the wheat seedlings were sprayed with the 2-amino-3-methylhexanoic acid solutions of the above concentrations. The treatment was repeated once after 24 h and conducted twice in total. After 24 h, fresh wheat powdery mildew spores were evenly scattered on the wheat leaves in three pots, with 20 plants per pot. After 10 days, the disease grade of wheat treated at each concentration was investigated. The disease degree was recorded according to the wheat powdery mildew grading standard in the Guidelines for the Field Efficacy Trials of Pesticides (I), and the disease index and relative immune effect were calculated by a method the same as that for calculating the disease index and relative immune effect of tomato spotted wilt. The results are shown in Table 2. At the same time, the middle segment of the last but one leaf of wheat was taken and the distribution of mycelia on the wheat leaves was observed by referring to Wolf and Fric's rapid staining method of powdery mildew. The results are shown in FIG. 2.

Grading standard of wheat powdery mildew (per leaf):
Grade 1: The diseased spot area accounts for 5% or less of the whole leaf area.
Grade 3: The diseased spot area accounts for 6-15% of the whole leaf area.
Grade 5: The diseased spot area accounts for 16-25% of the whole leaf area.
Grade 7: The diseased spot area accounts for 26-50% of the whole leaf area.
Grade 9: The diseased spot area accounts for 50% or more of the whole leaf area.

TABLE 2
Effect of 2-amino-3-methylhexanoic acid of different concentrations
on disease index and relative immune effect of wheat

| Treatment concentration | | Disease index | Relative immune effect |
|---|---|---|---|
| 0 | | 95.19 ± 1.28a | — |
| 1 | nM | 91.85 ± 1.70a | 3.50 |
| 10 | nM | 80.37 ± 2.31b | 15.56 |
| 100 | nM | 68.89 ± 2.22c | 27.63 |
| 1,000 | nM | 42.78 ± 3.85b | 55.06 |
| 10,000 | nM | 32.96 ± 1.40e | 65.37 |

The results in Table 2 show that with the increase of the concentration of 2-amino-3-methylhexanoic acid, the disease index of the susceptible wheat variety decreased, and the relative immune effect increased. Except that there was no significant difference in the disease index of wheat infected with powdery mildew between the blank control and 1 nM treatment groups, there were significant differences in the disease index of other treatment groups. When the concentration was 1 nM, 10 nM, 100 nM, 1,000 nM and 10,000 nM respectively, the disease index was 91.85, 80.37, 68.89, 42.78 and 32.96, and the relative immune effect was 3.5%, 15.56%, 27.63%, 55.06% and 65.37%. When the concentration of 2-amino-3-methylhexanoic acid was greater than 1,000 nM, the disease index of the susceptible wheat variety infected with powdery mildew was lower than 50, while the relative immune effect was more than 50%, and the effect was the best when the concentration was 10,000 nM. The results in FIG. 2 show that with the increase of the concentration of 2-amino-3-methylhexanoic acid, the number of powdery mildew fungus and conidia on the leaves of the susceptible wheat variety decreased significantly, which is consistent with the results in Table 2. The above results indicate that 2-amino-3-methylhexanoic acid can improve the immunity of wheat against the fungal disease powdery mildew, thereby inhibiting the infection and spread of powdery mildew fungus in wheat leaves and preventing the development and spread of wheat powdery mildew.

### EXAMPLE 3

### 2-amino-3-methylhexanoic Acid Induced Resistance of Arabidopsis to Pseudomonas syringae Infection

2-amino-3-methylhexanoic acid was dissolved in sterile water and then diluted with sterile water into solutions of 1 nM, 10 nM, 100 nM, 1,000 nM and 10,000 nM by gradient. A blank control was additionally set, and 0.02% Tween 20 was added as a surfactant. Pseudomonas syringae PstDC3000 was spread on an LB plate and cultured at 28° C. for 48 h. Monoclonal colonies were selected and transferred into a 50 mL centrifuge tube containing 2 mL of a culture medium, and cultured on a shaker at 28° C. and 250 rpm. The change of the OD₆₀₀ value of the bacterial solution was monitored every 1-2 h, and culture of bacteria was stopped before the OD₆₀₀ value reached 0.8. 1 mL of bacterial solution was transferred into a 1.5 mL sterile centrifuge tube and centrifuged at 8,000 rpm for 2 min, and the precipitate was collected. The supernatant was removed, the precipitate was washed with 10 mM magnesium chloride three times and centrifuged, and finally the PstDC3000 was suspended in 10 mM magnesium chloride to make the OD₆₀₀ value thereof reach 0.001 for use. Arabidopsis seeds were soaked in 75% alcohol for 3 min, then washed with sterile water 4 times, and sowed in a culture dish containing a ½ MS medium according to 12 seeds per culture dish. The ½ MS culture dish with seeds was vernalized at 4° C. for 3 days to break dormancy, and then placed in a culture room at 24° C. with a light intensity of 100 μEm⁻²s⁻¹ (16 h light/8 h dark). When the seedlings grew for 2 weeks, the 2-amino-3-methylhexanoic acid of different concentrations was slowly poured into the culture dish until the whole Arabidopsis seedlings were submerged, and after 2-3 min, the treatment solution was poured out of the culture dish. The treatment was repeated once after 24 h and conducted twice in total. 24 h after the second treatment, the Arabidopsis leaves were inoculated with the PstDC3000 suspension (OD₆₀₀=0.01) by the same submergence method. After inoculation, the culture dish was closed with a medical breathable adhesive tape, and placed in the culture room for further culture. 3 days later, the number of bacteria in different treatment groups was determined. The incidence of Arabidopsis was observed. The disease index was calculated by a formula the same as that in Example 1.

Grading standard of disease caused by PstDC3000 (per leaf):
Grade 0: No diseased spot on the leaf surface.
Grade 1: The diseased spot area accounts for 0-10% of the whole leaf area.
Grade 2: The diseased spot area accounts for 10-25% of the whole leaf area.
Grade 3: The diseased spot area accounts for 25-50% of the whole leaf area.
Grade 4: The diseased spot area accounts for 50-75% of the whole leaf area.
Grade 5: The diseased spot area accounts for 75-100% of the whole leaf area.

TABLE 3
Effects of 2-amino-3-methylhexanoic acid of different concentrations
on the number of bacteria and disease index in leaves

| Treatment concentration | CPU/mg | Disease index |
|---|---|---|
| 0 | 3.24 × 10⁶ | 87.33 ± 2.52a |
| 10 nM | 3.81 × 10⁵ | 45.00 ± 2.78b |
| 100 nM | 2.49 × 10⁵ | 41.48 ± 3.33b |

Table 3 shows that with the increase of the concentration of 2-amino-3-methylhexanoic acid, the number of bacteria in each milligram of leaf gradually decreased. When the treatment concentration was 10 nM and 100 nM, the number of bacteria in each milligram of leaf decreased by 88.24% and 92.31%, and the disease index decreased by 42.33 and 45.85 respectively. The results show that 2-amino-3-methylhexanoic acid can stimulate plants to produce immunity against Pseudomonas syringae, inhibit the accumulation of bacteria in plant leaves, and reduce the incidence of plant disease.

### EXAMPLE 4

### 2-amino-3-methylhexanoic Acid Induced Resistance of Ryegrass, Wheat and Tomato to High Temperature Stress

2-amino-3-methylhexanoic acid was dissolved in distilled water and diluted with distilled water into solutions of 1 nM, 10 nM, 100 nM and 1,000 nM by gradient. A blank control was additionally set, and 0.02% Tween 20 was added as a surfactant. 4 groups of repetitions were set for each concentration, and a normal temperature blank control was set at the same time. Ryegrass seeds were weighed according to 0.8 g per pot, sowed in a pot with a diameter of 8.5 cm, and planted in a greenhouse at a temperature of 25° C., a humidity of 60%-70%, and a light intensity of 200 μmolm⁻²s⁻¹ (12 h light/12 h dark). On the 8th day of the seedling stage, the ryegrass was sprayed with the 2-amino-3-methylhexanoic acid solutions on the leaves twice in 24 h. 24 h after the second treatment, the plants were transferred to a light incubator at a temperature of 45° C. for conducting high temperature stress treatment for 12 h, and then the plants were taken out and transferred to a greenhouse at a temperature of 25° C. for 7 days of recovery. The injured conditions of the plants were observed and counted, and the heat injury grade was calculated. Table 4 shows the grading standard of heat injury, and the heat injury index was calculated by a formula as follows. After the counting, the fresh weight of the aboveground part of the plant was weighed, and then the aboveground part was baked in an 85° C. oven for 48 h to determine the dry weight. Table 5 shows the results.

$$Heat injury index ( \% ) = \frac{\sum Number of plants at all grades \times Number of grades}{Highest grade \times Total number of treated plants} \times 100$$

Wheat seeds were weighed according to 1.5 g per pot, and planted by a method and under conditions the same as those of ryegrass. When the wheat grew for two weeks in the seedling stage, the experiment was conducted. High temperature stress was conducted for 9 h, and the treatment method and subsequent statistical indexes were the same as those of the ryegrass mentioned above. The results are shown in Table 6.

Tomato seeds were sowed in small pots, and three tomato seedlings with the same growth condition were transplanted into one pot after emergence. The planting method and conditions were the same as above. When the tomato grew for 18 days in the seedling stage, the experiment was conducted. High temperature stress was conducted at 42° C. for 9 h, and the treatment method and subsequent statistical indexes were the same as those of the above. The results are shown in Table 7.

TABLE 4
Grading standard of heat injury

| Grade of | |
|---|---|
| heat injury | Degree of injury |
| 0 | The plant grows normally. |
| 1 | Wilting of one-fourth or less of leaves |
| 2 | Wilting or yellowing of one-fourth to one-half of leaves |
| 3 | Wilting or yellowing of one-half to three-quarters of leaves |
| 4 | Wilting or yellowing of three-quarters or more of leaves |
| 5 | The plant is withered. |

TABLE 5
Biomass and heat injury index of ryegrass

| | | Fresh weight of | Dry weight of | Heat injury |
|---|---|---|---|---|
| Treatment | | overground part/g | overground part/g | index/% |
| Blank control | | 4.68 ± 0.29a | 0.51 ± 0.03a | 0 |
| 0 | | 0.99 ± 0.13c | 0.35 ± 0.02c | 90 |
| 1 | nM | 1.96 ± 0.19b | 0.4 ± 0.01bc | 70 |
| 10 | nM | 2.14 ± 0.095 | 0.46 ± 0.04ab | 60 |
| 100 | nM | 2.60 ± 0.02b | 0.44 ± 0.02nb | 30 |
| 1,000 | nM | 2.42 ± 0.15b | 0.45 ± 0.01ab | 30 |

The results in Table 5 show that the aboveground biomass and underground biomass after high temperature stress of ryegrass treated with the 2-amino-3-methylhexanoic acid were significantly higher than those of the blank control. The heat injury index decreased with the increase of the treatment concentration. It can be seen that, within a certain concentration range, the effect of the 2-amino-3-methylhexanoic acid inducing heat resistance of ryegrass is obviously concentration dependent. When the treatment concentration exceeded 100 nM, the heat injury index no longer decreased significantly, indicating that the optimal use concentration of the 2-amino-3-methylhexanoic acid for treating ryegrass to alleviate high temperature stress was 100 nM. When the treatment concentration was 100 nM, the fresh weight and dry weight of the aboveground part of ryegrass increased by 162% and 25% respectively compared with the untreated control group.

TABLE 6
Biomass and heat injury index of wheat

| | | Fresh weight of | Dry weight of | Heat injury |
|---|---|---|---|---|
| Treatment | | overground part/g | overground part/g | index/% |
| Blank control | | 8.94 ± 0.28a | 1.03 ± 0.02a | 0 |
| 0 | | 1.76 ± 0.01c | 0.72 ± 0.03bc | 80 |
| 10 | nM | 1.76 ± 0.13c | 0.72 ± 0.04bc | 85 |
| 100 | nM | 1.87 ± 0.12c | 0.75 ± 0.04c | 75 |
| 1,000 | nM | 2.11 ± 0.30c | 0.78 ± 0.05bc | 65 |
| 10,000 | nM | 3.57 ± 0.50b | 0.95 ± 0.04ab | 40 |

The results in Table 6 show that under the condition of 45° C., with the increase of the treatment concentration of the 2-amino-3-methylhexanoic acid, the fresh weight and dry weight of the aboveground part increased, and the heat injury index decreased. When the concentration was 10,000 nM, the fresh weight and dry weight of the aboveground part of wheat were 102.84% and 31.94% higher than those of the untreated control group respectively, and the heat injury index decreased by 40%. The results show that treatment with 2-amino-3-methylhexanoic acid effectively alleviated the inhibition of vegetative growth of wheat and the degree of plant injury caused by high temperature stress.

TABLE 7
Biomass and heat injury index of tomato

| | | Fresh weight of | Dry weight of | Heat injury |
|---|---|---|---|---|
| Treatment | | overground part/g | overground part/g | index |
| Blank control | | 1.03 ± 0.16a | 0.11 ± 0.03a | 0 |
| 0 | | 0.16 ± 0.02c | 0.05 ± 0.01h | 100 |
| 10 | nM | 0.30 ± 0.0.07bc | 0.05 ± 0.01b | 95 |
| 100 | nM | 0.61 ± 0.16abc | 0.06 ± 0.02h | 90 |
| 1,000 | nM | 0.85 ± 0.2la | 0.08 ± 0.003ab | 60 |

The results in Table 7 show that the optimum concentration of 2-amino-3-methylhexanoic acid inducing resistance of tomato to high temperature stress was 1,000 nM. The fresh weight of the aboveground part of tomato treated at this concentration was significantly higher than that of the untreated control group (P<0.05), and the heat injury index significantly decreased. In combination with the above results, it is indicated that the optimal concentrations of 2-amino-3-methylhexanoic acid for inducing resistance of different plants are also different. When the optimal concentrations were exceeded, the resistance inducing effect did not significantly increase.

### EXAMPLE 5

### 2-amino-3-methylhexanoic Acid Induced Resistance of Tea Plants to High Temperature and Improved Tea Quality

In August 2020, a field test was conducted in the Sun Yat-sen Mausoleum Tea Garden in Nanjing, and the tea variety was Longjing 43. During the test, the actual temperature of the field was 37.6° C.-45.1° C., the concentration of 2-amino-3-methylhexanoic acid was 0, 10, 100, 1,000 and 10,000 nM, and 0.02% Tween 20 was added as a surfactant. Three repetitions were set for each treatment group. In a plot area of 20 m², the liquid spraying volume per plot was 2 L. The pesticide was applied to the field three times on August 6, August 8 and Aug. 15, 2020 respectively. On the 3rd, 7th and 14th days after the last use of the pesticide, the phenotype of a tea tree was observed, and a leaf and a bud were sampled from the top of the tea tree. 15 leaves were taken for each treatment group, and the chlorophyll fluorescence parameter PI_{ABS} (maximum photosynthetic efficiency) of tea leaves was determined with a plant efficiency analyzer Handy-PEA. Samples were taken and the total amino acid content in tea leaves was determined on the 5th day after use of the pesticide, and the heat injury rate was calculated on the 10th day after use of the pesticide. The results are shown in Table 8 and Table 9.

At normal temperature, the effect of 2-amino-3-methylhexanoic acid on tea quality was determined using “Baiye 1” cutting seedlings as the tea trees tested. Tea seedlings with relatively consistent growth were transplanted into a plastic pot with a diameter of 18 cm and placed in a greenhouse at a temperature of 25° C. and a humidity of 60%-70% for adaptive growth for about a week. Two concentrations of 0 and 10 nM were set in the experiment, and 0.02% Tween 20 was added as a surfactant. 1 week after transplanting, the stems and leaves of the tea seedlings were sprayed once every 24 h, twice in total. After spray, the tea leaves were placed in a greenhouse at 25° C., and samples were taken on the 1st, 3rd, 5th and 7th days to determine the total amino acid content of one leaf and one bud at the top of tea leaves. The results are shown in Table 10.

TABLE 8
Effect of treatment with 2-amino-3-methylhexanoic
acid on the chlorophyll fluorescence parameter and
heat injury rate of tea leaves under heat stress

| | | | | | Heat |
|---|---|---|---|---|---|
| | | | | | injury |
| Treatment | | PI_{ABS} | | | rate |
| concentration | | 3 d | 7 d | 14 d | (%) |
| 0 | | 4.17 ± 0.35d | 5.62 ± 0.43b | 14.43 ± 0.66c | 42 |
| 10 | nM | 6.25 ± 0.51c | 6.43 ± 0.44b | 14.44 ± 0.59c | 30 |
| 100 | nM | 8.26 ± 0.63b | 8.07 ± 0.36a | 19.29 ± 0.95b | 17 |
| 1,000 | nM | 8.48 ± 0.61ab | 8.14 ± 0.70a | 19.85 ± 1.04ab | 15 |
| 10,000 | nM | 8.68 ± 0.56a | 8.36 ± 0.51a | 21.97 ± 0.88a | 14 |

Table 8 shows that under high temperature stress, with the increase of the treatment concentration of 2-amino-3-methylhexanoic acid, the heat injury rate of tea leaves decreased. The 2-amino-3-methylhexanoic acid solution of 10,000 nM had the optimal resistance inducing effect on the tea leaves, and the PI_{ABS} at the 3rd, 7th and 14th days after use of the pesticide were respectively 108%, 48% and 52% higher than that in the control group (P<0.05). This result indicates that treatment with the 2-amino-3-methylhexanoic acid may effectively alleviate the injury of the photosynthetic system caused by high temperature stress, maintain high photosynthetic activity, and thus enhance the heat tolerance of tea leaves.

TABLE 9
Effect of treatment with 2-amino-3-methylhexanoic acid on the total
amino acid content of tea leaves under high temperature stress

| Treatment concentration | Amino acid content (% DW) |
|---|---|
| 0 | 1.66 ± 0.12c |

| | | |
|---|---|---|
| 10 | nM | 2.03 ± 0.05b |
| 100 | nM | 2.21 ± 0.32a |
| 1,000 | nM | 2.20 ± 0.05a |
| 10,000 | nM | 2.23 ± 0.08a |

The results in Table 9 show that the total amino acid content in tea leaves treated with the 2-amino-3-methylhexanoic acid was significantly higher than that in the control group, and the total amino acid content increased by 22%, 33%, 33% and 34% respectively (P<0.05). When the treatment concentration exceeded 100 nM, the amino acid content in tea leaves did not increase. This result indicates that the optimum use concentration of 2-amino-3-methylhexanoic acid was 100 nM, at which accumulation of amino acids in tea leaves could be promoted after spraying, thus improving the tea quality.

TABLE 10
Effect of 2-amino-3-methylhexanoic acid on the amino
acid content of tea leaves at room temperature

Day

| Treatment | 1 | 3 | 5 | 7 |
|---|---|---|---|---|
| Control | 1.82 | 2.13 | 1.94 | 1.97 |
| 10 nM | 2.13 | 2.44 | 2.69 | 2.08 |

The results in Table 10 indicate that the amino acid content in tea leaves treated with 10 nM 2-amino-3-methylhexanoic acid at room temperature significantly increased compared with the control, and increased by 14% and 26% compared with the control on the 3rd and 5th days. Therefore, in actual production, tea leaves may be picked on the 5th day after 2-amino-3-methylhexanoic acid is sprayed to ensure that the tea quality is the best.

### EXAMPLE 6

### 2-amino-3-methylhexanoic Acid Induced Resistance of Wheat to Drought Stress

Wheat was cultured in water in a 6-mesh sieve used as a container according to 50 grains per sieve, and ½ Hoagland nutrient solution was changed every three days. When the wheat grew to the stage of two leaves and one bud, the leaf surface was sprayed with 2-amino-3-methylhexanoic acid solutions, the concentration of the 2-amino-3-methylhexanoic acid was 0, 100 and 1,000 nM, and 0.02% Tween 20 was added as a surfactant. After two days of continuous spraying, the water culture nutrient solution was replaced with ½ Hoagland nutrient solution containing 25% PEG-6000 on the 3rd day for stress treatment. After 6 days of drought stress, rehydration treatment was conducted. After 7 days of recovery growth in a normal nutrient solution, the drought index was observed and determined, and the root length and biomass were determined. The results are shown in Table 12.

The performance characteristics of drought injury of leaves are similar to those of salt injury. The drought injury rate and the drought injury index were introduced by using the evaluation indexes of salt injury. The formula for calculating the drought injury index is as follows, and the grading standard of drought injury is shown in Table 11.

$$Drought injury index ( \% ) = \frac{\sum \begin{matrix}Grade of \\ drought injury\end{matrix} \times \begin{matrix}Number of corresponding \\ drought injured plants\end{matrix}}{\begin{matrix}Total number \\ of pants\end{matrix} \times \begin{matrix}Highest grade of \\ drought injury\end{matrix}} \times 100$$

TABLE 11
Grading standard of drought injury

| Grade of | |
|---|---|
| drought injury | Degree of injury |
| 0 | No symptoms of drought injury |
| 1 | Slight drought injury, with yellowing of a few leaf tips, |
| | leaf margins or veins |
| 2 | Moderate drought injury, with withering of about one- |
| | half of leaf tips and leaf margins |
| 3 | Severe drought injury, with withering or falling of most |
| | of leaf tips and leaf margins |

TABLE 12
Effect of treatment with 2-amino-3-methylhexanoic acid on the
biomass and heat injury index of wheat under drought stress

| | | Fresh weight | | Dry weight | | | Drought |
|---|---|---|---|---|---|---|---|
| Treatment | | Overground | Underground | Overground | Underground | Length | injury |
| concentration | | part | part | part | part | of root | index/% |
| 0 | | 6.42 ± 0.71b | 3.32 ± 0.42a | 0.80 ± 0.01a | 0.32 ± 0.05a | 13.64 ± 0.20b | 66 |
| 100 | nM | 6.71 ± 0.69b | 3.48 ± 0.40a | 0.79 ± 0.01a | 0.34 ± 0.02a | 13.83 ± 0.26b | 50 |
| 1,000 | nM | 8.72 ± 0.59a | 4.46 ± 0.01a | 0.88 ± 0.05a | 0.38 ± 0.02a | 14.50 ± 0.27a | 30 |

The results in Table 12 show that under drought stress, compared with the control group, the root length of wheat seedlings treated with the 2-amino-3-methylhexanoic acid at a concentration of 1,000 nM significantly increased by 6%, meanwhile, the drought index decreased by 36%, the fresh weight of aboveground and underground parts increased by 35.82% and 34.33% respectively, and the dry weight of the aboveground and underground parts increased by 10.00% and 18.75% respectively, indicating that the 2-amino-3-methylhexanoic acid could improve the resistance of wheat to drought stress.

### EXAMPLE 7

### 2-amino-3-methylhexanoic Acid Induced Resistance of Cotton to Salt Stress

The experimental material was “Sikang 1” cotton, which was cultured in water in a 500 mL plastic cup, and a ½ Hoagland nutrient solution was changed every three days. When the cotton seedling grew until the second true leaf fully unfolded, the leaf surface was sprayed with 2-amino-3-methylhexanoic acid solutions. The concentrations of 0, 1, 10, 100 and 1,000 nM were set in the experiment, and 0.02% Tween 20 was added as a surfactant. The spraying was repeated once after 24 h and conducted twice in total. On the second day after the treatment, NaCl was added to the ½ Hoagland nutrient solution to a final concentration of 100 mM to conduct salt stress treatment. There were three repetitions in each treatment group. Rehydration treatment was conducted after three days of salt stress, the salt injury symptoms of cotton were observed, and the salt injury index was calculated by a formula as follows:

$$Salt injury index ( \% ) = \frac{\sum \begin{matrix}Diseased plants \\ recorded at all grades\end{matrix} \times \begin{matrix}Number of corresponding \\ grades\end{matrix}}{\begin{matrix}Total number of \\ plants investigated\end{matrix} \times \begin{matrix}Highest grade of \\ salt injury\end{matrix}} \times 100$$

TABLE 13
Grading standard of salt injury

| Grade of | |
|---|---|
| salt injury | Degree of injury |
| 1 | The plant height and the number of leaves are equivalent to |
| | those of the control treatment, the plant is robust, and the |
| | leaves are flat, green and shiny. The plant grows normally |
| | without symptoms of injury. |
| 2 | The plant height is 70%-100% of the control, the number of |
| | true leaves is 0.5-1.0 less than that of the control treatment, |
| | the cotyledons are flat, the symptoms of salt injury are not |
| | obvious, and the growth is basically normal. |
| 3 | The plant height is 50%-70% of that of the control, the |
| | number of true leaves is 1.0 less than that of the control, |
| | and the cotyledon margin is curly. |
| 4 | The plant height is 50% or less of the control. There is no |
| | true leaf, only the heart leaf survives, the growth point is |
| | passivated, the cotyledon is dark green and shrunk, and the |
| | margin is curled. |
| 5 | The cotyledons fall off, and the plant withers and dies. |

TABLE 14
Effect of treatment with 2-amino-3-methylhexanoic
acid on cotton under salt stress

| Treatment concentration | | Salt injury index (%) | Death rate (%) |
|---|---|---|---|
| 0 | | 73 | 63 |
| 1 | nM | 67 | 50 |
| 10 | nM | 63 | 50 |
| 100 | nM | 56 | 33 |
| 1,000 | nM | 47 | 33 |

The results in table 14 show that the salt injury index of cotton decreased with the increase of the concentration of 2-amino-3-methylhexanoic acid, and the plant mortality of each treatment group was lower than that of the control. When the concentration was 1,000 nM, the salt injury index and the mortality rate were the lowest, which were 47% and 33% respectively. The above results indicate that the 2-amino-3-methylhexanoic acid could induce cotton to produce better resistance to salt stress.

### EXAMPLE 8

### 2-amino-3-methylhexanoic Acid Induced Resistance of Tea to Low Temperature Stress

The tea trees tested were “Baiye 1” cutting seedlings. Tea seedlings with relatively consistent growth were transplanted into a plastic pot with a diameter of 18 cm and placed in a greenhouse at a temperature of 25° C. and a humidity of 60%-70% for adaptive growth for about a week. The concentrations of 0, 1, 10, 100 and 1,000 nM were set in the experiment, and 0.02% Tween 20 was added as a surfactant. The spray treatment method was the same as that of the ryegrass in Example 4, and the low temperature stress treatment was conducted at −4° C. for 24 h. After the stress was completed, the tea seedlings were taken out and treated in the dark at room temperature for 30 min, and then the chlorophyll fluorescence parameters of the top leaves of the tea seedlings was determined using the plant efficiency analyzer Handy PEA. Then, the tea seedlings were placed in a 25° C. greenhouse to recover for 3 days, and the cold injury status was observed, counted and graded. Table 15 shows the statistical grading standard of the cold injury index. The calculation formula is as follows, and the results are as shown in Table 16.

$$Cold injury index ( \% ) = \frac{\sum Grade of cold injury \times \begin{matrix}Number of plants at corresponding \\ grades of cold injury\end{matrix}}{Highest grade of cold injury \times Total number of plants} \times 100$$

TABLE 15
Grading standard of cold injury

| Grade of | |
|---|---|
| cold injury | Degree of injury |
| 0 | The plant grows normally |
| 1 | Slight water loss at the leaf margin |
| 2 | Serious water loss at the leaf margin |
| 3 | Serious water loss at the leaf margin, and spots on the leaf |
| 4 | Serious water loss at the leaf margin, connected spots on the |
| | leaf, and shriveling of some leaves |
| 5 | Water loss, shriveling and wilting of the whole leaf |

TABLE 16
Effect of treatment with 2-amino-3-methylhexanoic
acid on tea leaves under low temperature stress

| Treatment | | |
|---|---|---|
| concentration | PI_{ABS} | Cold injury index (%) |
| 0 | 7.37 ± 1.55c | 75 |

| | | | |
|---|---|---|---|
| 1 | nM | 17.69 ± 2.12b | 45 |
| 10 | nM | 21.30 ± 1.73ab | 30 |
| 100 | nM | 27.01 ± 3.27a | 15 |
| 1,000 | nM | 30.42 ± 3.51a | 10 |

The results in Table 16 show that under low temperature stress, the tea leaves treated with the 2-amino-3-methylhexanoic acid had significantly increased photosynthetic performance index PI_{ABS} and significantly decreased cold injury index. The treatment effect at 1,000 nM was the best, and the tea leaves treated at this concentration had a PI_{ABS} increased by 313%, and a cold injury index decreased by 65%. It can be seen that the 2-amino-3-methylhexanoic acid significantly alleviated the injury to the photosynthetic system of the tea seedlings caused by low temperature stress, and improved the resistance of tea leaves to low temperature stress.

### REFERENCES

[1] Sugiura M, Kisumi M, Chibata I. β-methylnorleucine, an antimetabolite produced by Serratia marcescens [J]. Journal of Antibiotics 1981, 34(10): 1278-82.
[2] Sugiura M, Kisumi M, Chibata I. Biosynthetic pathway of beta-methylnorleucine, an antimetabolite produced by Serratia marcescens [J]. Journal of Antibiotics, 1981, 34(10):1283-9.
[3] Sugiura M, Kisumi M, Chibata I. β-methylnorleucine, a novel antagonist of isoleucine. Agricultural and Biological Chemistry 1985, 49(6): 1889-1890.
[4] Muramatsu R, Negishi T, Mimoto T, Miura A, Misawa S, Hayashi H. Existence of β-methylnorleucine in recombinant hirudin produced by Escherichia coli [J]. Journal of Biotechnology 2002, 93 (2): 131-142.
[5] Muramatsu R, Misawa S, Hayashi H. Finding of an isoleucine derivative of a recombinant protein for pharmaceutical use. Journal of Pharmaceutical and Biomedical Analysis 2003, 31: 979-987.
[6] Qiang Sheng, Zhang Qian, Wang Zhongchang, Zhu Hailiang, Chen Shiguo. A synthesis method of alkyl glycine. Chinese invention patent, use No. 201810359759.7.
[7] Ocampo T O, Peralta S M G, Bacheller N, Uiterwaal S, Garcia-Ruiz H. Antiviral RNA silencing suppression activity of Tomato spotted wilt virus NSs protein [J]. Genetics & Molecular Research 2016, 15(2): 10.4238/gmr.15028625.
[8] GB/T 23222-2008, Grade and investigation method of tobacco diseases and insect pests [S].
[9] Wolf G. A rapid staining method for Erysiphe graminis f. sp. hordei in and on whole barley leaves with a protein-specific dye [J]. Phytopathology 1981, 71(6): 596-598.
[10] State Bureau of Quality and Technical Supervision. Pesticide—Guidelines for the field efficacy trials (I) [M] Beijing: China Standards Press, 2000, pp. 90-93.
[11] GB/T 8314-2013, Tea—Determination of free amino acids content [S].
[12] Wang Xiuping, Zhang Guoxin, et al. Rules for characterization and evaluation of cotton salt tolerance (DB13/T1339-2010) [S]. Hebei Provincial Local Standard, 2010.

1. Use of 2-amino-3-methylhexanoic acid in preparation of a plant immunity inducer.

2. Use of 2-amino-3-methylhexanoic acid in improving resistance of plants to abiotic or biotic stresses, wherein the abiotic stresses are selected from high temperature, low temperature, drought and/or salt stresses, and the biotic stresses are selected from fungal disease, bacterial disease and viral disease stresses, the fungal disease being wheat powdery mildew, the bacterial disease being Pseudomonas syringae infection, and the viral disease being tomato spotted wilt.

3. The use according to claim 1, wherein the plant is selected from food crops, cash crops and vegetables.

4. The use according to claim 3, wherein the food crops are wheat, the cash crops are tea, cotton and ryegrass, and the vegetables are tomato.

5. A method for improving resistance of plants to abiotic stress, comprising: applying 2-amino-3-methylhexanoic acid to plants, the abiotic stress being selected from any one or more of high temperature, low temperature, drought and/or salt stresses.

6. The use according to claim 2, wherein the plant is selected from food crops, cash crops and vegetables.

7. The use according to claim 6, wherein the food crops are wheat, the cash crops are tea, cotton and ryegrass, and the vegetables are tomato.
